(19) United States
(12) Patent Application Publication
(10) Pub. No.: US 2024/0234971 A1
(43) Pub. Date: Jul. 11, 2024

(54) ELECTRODE LEAD STRUCTURE FOR SECONDARY BATTERY AND SECONDARY BATTERY INCLUDING THE SAME

(71) Applicant: SK On Co., Ltd., Seoul (KR)

(72) Inventor: Joo Ho MOON, Daejeon (KR)

(21) Appl. No.: 18/389,781

(22) Filed: Dec. 20, 2023

(30) Foreign Application Priority Data
Jan. 6, 2023 (KR) 10-2023-0002196

(51) Int. Cl. H01M 50/533; H01M 50/534

(52) U.S. Cl. CPC H01M 50/533; H01M 50/534

(57) ABSTRACT

An electrode lead structure for a secondary battery includes is disclosed. In some implementations, the electrode lead structure for a secondary battery includes an electrode lead having a hole and a lead film formed on the electrode lead, wherein the hole is provided to be spaced apart from an end of the electrode lead, and the lead film fills the hole.

### CROSS-REFERENCE TO RELATED APPLICATION(S)

This patent document claims the priority and benefits of Korean Patent Application No. 10-2023-0002196 filed on Jan. 6, 2023, the disclosure of which is incorporated herein by reference in its entirety.

### TECHNICAL FIELD

The technology and implementations disclosed in this patent document generally relate to an electrode lead structure for a secondary battery and a secondary battery including the same, and more particularly, to an electrode lead structure for a secondary battery having improved adhesion to a battery case and a secondary battery including the same.

### BACKGROUND

As interest in environmental issues has grown recently, exhaust gases emitted from vehicles powered by fossil fuels, such as gasoline or diesel, have been identified as one of the main causes of air pollution, and electric vehicles (EVs), hybrid electric vehicles (HEV), and the like have been studied extensively as alternatives.

In addition, lithium secondary batteries with high discharge voltage and power stability have mainly been used as a power source for electric vehicles (EV), hybrid electric vehicles (HEV), and the like, and accordingly, research to improve the safety of lithium secondary batteries has been actively conducted.

In general, lithium secondary batteries have a risk of explosion due to high temperature and high pressure inside the batteries caused by abnormal factors, such as internal short-circuits, overcharging exceeding the permitted current and voltage, exposure to high temperatures, and shocks from falling.

In particular, when the above abnormal factors occur in a lithium secondary battery, a component, such as an electrolyte of the lithium secondary battery, may leak externally, causing a stronger explosion. Meanwhile, the lithium secondary battery includes an electrode lead exposed externally to be electrically connected to an external device. If the above abnormal factors occur in the lithium secondary battery, the components of the lithium secondary battery may leak externally through the electrode lead. To solve these problems, technology to improve adhesion between a battery case and electrode leads of lithium secondary batteries is required.

### SUMMARY

The disclosed technology may be implemented in some exemplary embodiments to provide an electrode lead structure for a secondary battery having improved adhesion to a battery case and a secondary battery including the same.

In some exemplary embodiments of the disclosed technology, an electrode lead structure for a secondary battery includes: an electrode lead having a hole; and a lead film formed on the electrode lead, wherein the hole is provided to be spaced apart from an end of the electrode lead, and the lead film fills the hole.

The hole may be spaced at least 2.5 mm apart from the end of the electrode lead.

The hole may be provided in plural in the electrode lead.

The holes may be spaced apart from each other by 5 mm or less.

The lead film may include polypropylene, polyethylene, and naphthalate.

In some exemplary embodiments of the disclosed technology, a secondary battery includes: an electrode assembly including a negative electrode plate, a positive electrode plate, and a separator; an electrode tab formed at one end of the electrode assembly; the electrode lead structure for a secondary battery according to any one of claims 1 to 6, one end of which is coupled to the electrode tab; and a battery case wrapping the electrode assembly and the electrode tab and adhered to the lead film of the electrode lead structure.

The lead film may have adhesion of 4 to 5 N/mm with the battery case.

The battery case may include an upper case and a lower case adhered by the lead film, and the upper case and the lower case may have adhesion of 8 to 10 N/mm due to the lead film.

### BRIEF DESCRIPTION OF DRAWINGS

Certain aspects, features, and advantages of the disclosed technology are illustrated by the following detailed description with reference to the accompanying drawings.

FIG. 1 is a perspective view illustrating a secondary battery according to an exemplary embodiment of the present disclosure.

FIGS. 2 and 3 are a plan view and a cross-sectional view illustrating an electrode lead structure for a secondary battery according to an exemplary embodiment of the present disclosure.

FIGS. 4 to 6 are plan views and a cross-sectional view illustrating a method of manufacturing an electrode lead structure for a secondary battery according to an exemplary embodiment of the present disclosure.

### DETAILED DESCRIPTION

Hereinafter, the configuration and operation of the present disclosure will be described in detail with reference to the exemplary embodiments of the present disclosure illustrated in the accompanying drawings.

As the inventive concept allows for various changes and numerous exemplary embodiments, particular exemplary embodiments will be illustrated in the drawings and described in detail in the written description. Effects and features of the present disclosure, and a method for achieving them will become apparent with reference to the exemplary embodiments described below in detail in conjunction with the drawings. However, the present disclosure is not limited to the exemplary embodiments disclosed below and may be implemented in various forms.

Hereinafter, the exemplary embodiments of the present disclosure will be described in detail with reference to the accompanying drawings. The same or corresponding elements will be consistently denoted by the same respective reference numerals and redundant descriptions thereof will be omitted.

In the following exemplary embodiments, terms, such as first, second, etc. Are used for the purpose of distinguishing one component from another, not in a limiting sense.

Also, a singular expression includes a plural expression unless the context clearly dictates otherwise.

In addition, terms, such as “including” or “having” means that the features or components described in the specification are present, and do not preclude the possibility that one or more other features or components will be added.

In addition, in the drawings, the size of the components may be exaggerated or reduced for convenience of description. For example, the size and thickness of each component shown in the drawings are arbitrarily indicated for convenience of description, so the present disclosure is not limited thereto.

When a certain exemplary embodiment may be implemented differently, a specific process order may be performed differently from the described order. For example, two consecutively described processes may be performed substantially at the same time or performed in an order opposite to the described order.

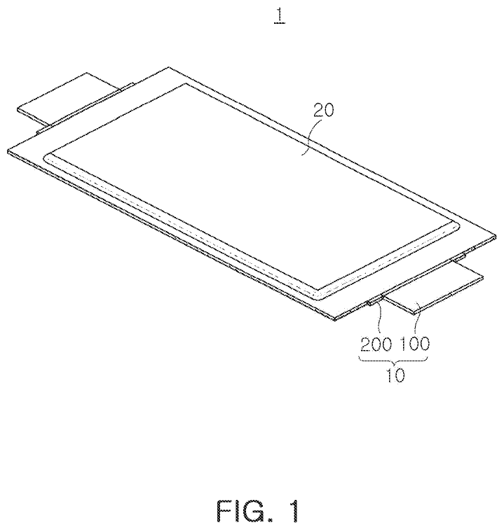

FIG. 1 is a perspective view illustrating a secondary battery according to an exemplary embodiment of the present disclosure.

Referring to FIG. 1, a secondary battery 1 may include an electrode assembly (not shown), an electrode tab (not shown), an electrode lead structure 10 for a secondary battery, and a battery case 20.

The electrode assembly may include a negative electrode plate, a positive electrode plate, and a separator. In detail, the electrode assembly may include one or more negative electrode plates and one or more positive electrode plates disposed with the separator interposed therebetween. That is, the electrode assembly may have a stacked structure of positive electrode plate/separator/negative electrode plate, and a plurality of positive electrode plates and a plurality of negative electrode plates may be alternately stacked.

In exemplary embodiments, the electrode assembly may be a jelly-roll (wound type) electrode assembly having a structure in which the positive electrode plates and the negative electrode plates in the form of a long sheet are wound with the separator interposed therebetween, or a stacked (layered) electrode assembly in which a plurality of the positive electrode plates and a plurality of negative electrode plates cut to have a predetermined size are sequentially stacked with a separator interposed therebetween.

In exemplary embodiments, the negative electrode plate and the positive electrode plate may have a structure in which a mixture layer is formed on a current collector. Here, there may be an uncoated portion in which the mixture layer is not formed.

The electrode tab may be formed by cutting the uncoated portion into a predetermined shape. That is, the electrode tab may be formed at one end of the electrode assembly.

The electrode tab may include a positive electrode tab formed at one end of a positive electrode of the electrode assembly and a negative electrode tab formed at one end of a negative electrode of the electrode assembly. When the electrode assembly includes a plurality of positive electrodes and a plurality of negative electrodes, the positive electrode tab and the negative electrode tab may be formed at one end of each of the positive electrodes and one end of each of the negative electrodes.

One end of the electrode lead structure 10 for a secondary battery may be coupled to the electrode tab, and the other end thereof may be exposed to the outside of the secondary battery 1. In other words, the electrode lead structure 10 may perform a function of electrically connecting the secondary battery 1 to an external device.

The electrode lead structure 10 may include a negative electrode lead structure coupled to the negative electrode tab and a positive electrode lead structure coupled to the positive electrode tab.

In exemplary embodiments, the electrode lead structure 10 may be coupled to the electrode tab by a method, such as welding, and thus, the electrode lead structure 10 may be electrically connected to the electrode tab.

Meanwhile, when the secondary battery 1 includes a plurality of negative electrode tabs and a plurality of positive electrode tabs, the negative electrode tabs, in a state of overlapping each other, coupled to one negative electrode lead structure, and the positive electrode tabs, in a state of overlapping each other, may be coupled to one positive lead structure.

The electrode lead structure 10 may include an electrode lead 100 and a lead film 200.

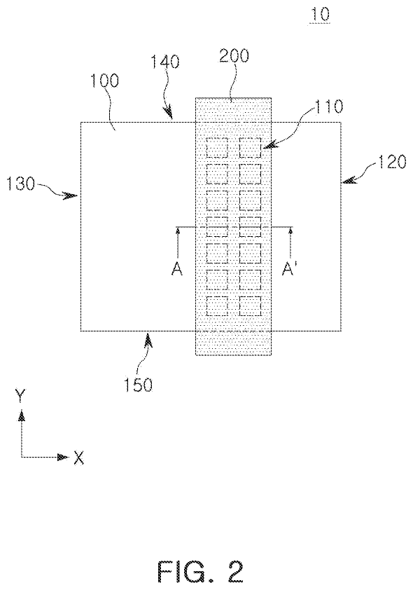

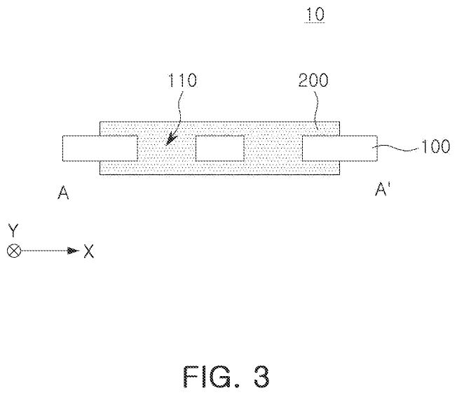

A detailed structure and characteristics of the electrode lead structure 10 will be described in detail below with reference to FIGS. 2 and 3.

The battery case 20 wraps the electrode assembly and the electrode tab and may be adhered to the lead film 200 of the electrode lead structure 10.

In exemplary embodiments, the battery case 20 may have a concave internal space, and the electrode assembly, the electrode tab, an electrolyte, etc. may be accommodated in the internal space.

In example exemplary embodiments, the battery case 20 may include an upper case and a lower case. In addition, the upper case and the lower case may be adhered to the lead film 200 of the electrode lead structure 10. That is, the upper case and the lower case may have adhesion due to the lead film 200.

In exemplary embodiments, the battery case 20 may include an external insulating layer formed of a polymer material, an internal adhesive layer, and a metal layer provided between the external insulating layer and the internal adhesive layer. Here, aluminum (Al) may be used as a material for the metal layer, but the present disclosure is not limited thereto.

FIGS. 2 and 3 are a plan view and a cross-sectional view illustrating an electrode lead structure for a secondary battery according to an exemplary embodiment of the present disclosure. Specifically, FIG. 2 is a plan view, and FIG. 3 is a cross-sectional view taken along line A-A′ of the plan view of FIG. 2.

Referring to FIGS. 2 and 3, the electrode lead structure 10 for a secondary battery may include the electrode lead 100 and the lead film 200 formed on the electrode lead 100.

The electrode lead 100 may have a hole 110 penetrating through the electrode lead 100.

The hole 110 may be provided to be spaced apart from the end of the electrode lead 100.

In an exemplary embodiment, the hole 110 may be spaced apart from the end of the electrode lead 100 by at least about 2.5 mm.

Meanwhile, the electrode lead 100 may include a first end 120, which is one end of the electrode lead 100, in a first direction (an X-direction) as a longitudinal direction, a second end 130, which is the other end opposite to the first end 120, a third end 140 in a second direction (a Y-direction) crossing the first direction, and a fourth end 150 t, which is the other end opposite to the third end 140.

The first end 120 may be coupled to the electrode tab, and the second end 130 may be exposed to the outside of the secondary battery 1.

In an exemplary embodiment, the holes 110 may each be spaced apart from the third end 140 and the fourth end 150 by about 5 mm or more.

In exemplary embodiments, a plurality of holes 110 may be provided in the electrode lead 100.

In some exemplary embodiments, the holes 110 may be spaced apart from each other by about 5 mm.

In exemplary embodiments, the hole 110 may be provided to have a small cross-sectional area in the electrode lead 100.

In an exemplary embodiment, the hole 110 may have a cross-sectional area of about 5 to 25 mm².

In example exemplary embodiments, the hole 110 may have various shapes, such as square, circle, or triangle.

FIGS. 2 and 3 show that fourteen holes 110 are provided in the electrode lead 100 and have a quadrangular shape, but the present disclosure is not limited thereto, and the holes 110 less than or greater than 14 holes may be provided in the electrode lead 100 and may have a shape other than a quadrangle.

The lead film 200 may be formed on the electrode lead 100.

The lead film 200 may be formed on upper and lower surfaces of the electrode lead 100 to ensure an insulation state of the secondary battery 1 and to adhere the electrode lead 100 to the battery case 20.

In exemplary embodiments, the lead film 200 may be formed to be spaced apart from the first end 120 and the second end 130 of the electrode lead 100.

The lead film 200 may be formed to fill the hole 110. That is, the lead film 200 may be formed on the upper and lower surfaces of the electrode lead 100 and may be formed to fill the hole 110, thereby improving the adhesion between the electrode lead 100 and the battery case 20, and as a result, the adhesion between the upper case and the lower case may be improved.

In addition, as the holes 110 are provided to be spaced apart from the end of the electrode lead 100, the holes 110 are formed to be concentrated on the center of the electrode lead 100, so that the adhesion between the electrode lead 100 and the battery case 20 and the adhesion between the upper case and the lower case may be further improved.

Due thereto, the electrode lead structure 10 may improve the safety of the secondary battery 1 by preventing the components of the secondary battery 1 from leaking to the outside of the secondary battery 1.

In an exemplary embodiment, the lead film 200 may have adhesion of about 4 to about 5 N/mm with the battery case 20.

In an exemplary embodiment, the upper case and the lower case may have adhesion of about 8 to about 10 N/mm due to the lead film 200.

In an exemplary embodiment, the lead film 200 may include, for example, polypropylene, polyethylene, and naphthalate.

As described above, the electrode lead structure 10 may include the electrode lead 100 having the hole 110 and the lead film 200 formed on the electrode lead 100 to fill the hole 110, and the hole 110 is provided to be spaced apart from the end of the electrode lead 100, and accordingly, the lead film 200 may improve the adhesion between the electrode lead 100 and the battery case 20 and the adhesion between the upper case and the lower case.

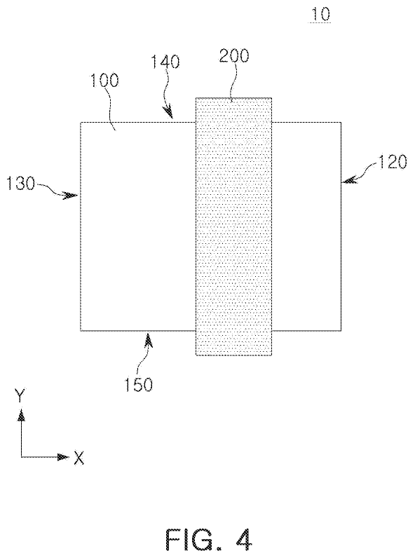

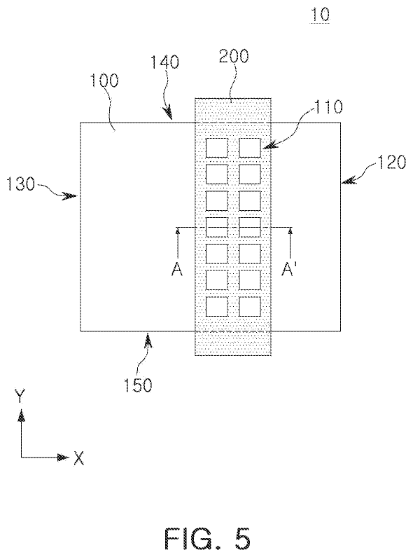

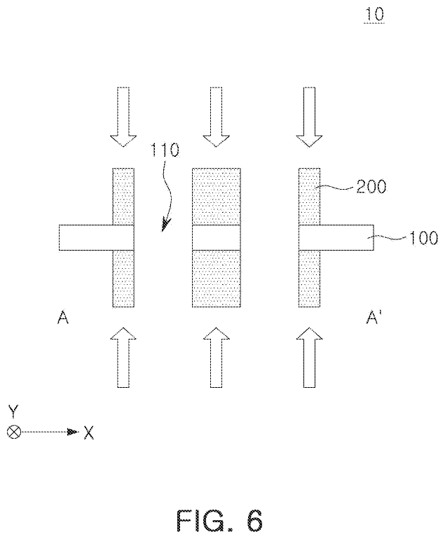

FIGS. 4 to 6 are plan views and a cross-sectional view illustrating a method of manufacturing an electrode lead structure for a secondary battery according to an exemplary embodiment of the present disclosure. Specifically, FIGS. 4 and 5 are plan views, and FIG. 6 is a cross-sectional view taken along line A-A′ of the plan view of FIG. 5.

Referring to FIG. 4, a lead film 200 may be formed on the electrode lead 100.

The lead film 200 may be formed on the upper and lower surfaces of the electrode lead 100.

Referring to FIGS. 5 and 6, the hole 110 may be formed by punching the electrode lead 100 and the lead film 200.

In an exemplary embodiment, the punching may be performed using a device, such as a perforator.

Thereafter, a hot press process may be performed on the lead film 200. Here, the lead film 200 may be pressed and melted into the hole 110. That is, the lead film 200 may be formed to fill the hole 110 through the hot press process (please refer to FIGS. 2 and 3).

As a result, manufacturing of the electrode lead structure 10 may be completed.

In an exemplary embodiment, the hot press process may be performed at a pressure of about 0.45 MPa and a temperature of about 200° C.

In an exemplary embodiment, the hot press process may be performed for about 4 seconds.

### EXAMPLE

Hereinbelow, the present disclosure will be described in more detail through specific examples. The following examples are merely examples to help understanding of the present disclosure, and the scope of the present disclosure is not limited thereto.

### Example 1

Lead films were formed on upper and lower surfaces of electrode lead A, and the electrode lead A and lead films were punched to form 10 holes having a cross-sectional area of 10 mm². Here, the holes were formed to be spaced apart from the first end by at least 2.5 mm, spaced apart from the second end by at least 2.5 mm, spaced apart from the third end by at least 5 mm, and spaced apart from the fourth end by at least 5 mm. Thereafter, a hot press process was performed on the lead films so that the lead films filled the holes. In this manner, the electrode lead structure A was manufactured.

### Comparative Example 1

After lead films were formed on upper and lower surfaces of electrode lead B, a hot press process was performed on the lead films. In this manner, the electrode lead structure B was manufactured.

### Comparative Example 2

Lead films were formed on upper and lower surfaces of electrode lead C, and the electrode lead C and lead films were punched to form 10 holes having a cross-sectional area of 10 mm². Here, the holes were formed to be spaced apart from the first end by at least 2.5 mm, spaced apart from the second end by at least 2.5 mm, and were formed at the third and fourth ends. Thereafter, a hot press process was performed on the lead films so that the lead films filled the holes. In this manner, the electrode lead structure C was manufactured.

### Measurement of Adhesion

A battery case in which an electrode assembly, an electrode tab, and an electrolyte were received was prepared, the electrode lead structures of Example 1 and Comparative Examples 1 and 2 were interposed between an upper case and a lower case, and then the upper case and the lower case were adhered to the electrode lead structure, thereby manufacturing secondary batteries of Example 1 and Comparative Examples 1 and 2.

Thereafter, the lower case was fixed, and the upper case was detached. Here, the adhesion was measured by measuring force N applied when the upper case was detached by 1 mm from the lower case.

The results of the measurement of adhesion are shown in Table 1 below.

TABLE 1

| | Adhesion between upper case |
|---|---|
| | and lower case (N/mm) |
| Example 1 | 8 |
| Comparative Example 1 | 5 |
| Comparative Example 2 | 6 |

As can be seen from Table 1, it was confirmed that the adhesion between the upper case and the lower case of Example 1 was greater than the adhesion between the upper case and the lower case of Comparative Example 1. Based on this, it can be seen that, the lead film 200 of the present disclosure is formed to fill the hole 110 to improve the adhesion between the electrode lead 100 and the battery case 20, and ultimately improve the adhesion between the upper case and the lower case.

In addition, it was confirmed that the adhesion between the upper case and the lower case of Example 1 was greater than that between the upper case and the lower case of Comparative Example 2. Based on this, as the holes 110 of the present disclosure are provided to be spaced apart from the end of the electrode lead 100, the holes 110 are formed to be concentrated on the center of the electrode lead 100, and thus, it can be seen that, the adhesion between the electrode lead 100 and the battery case 20 and the adhesion between the upper case and the lower case are further improved.

The electrode lead structure for a secondary battery according to the present disclosure includes the electrode lead having a hole and the lead film formed on the electrode lead to fill the hole, the hole is provided to be spaced apart from the end of the electrode lead, and accordingly, the lead film may improve the adhesion between the electrode lead and the battery case.

Due thereto, the electrode lead structure may improve the safety of the secondary battery by preventing the components of the secondary battery from leaking to the outside of the secondary battery.

Only specific examples of implementations of certain exemplary embodiments are described. Variations, improvements and enhancements of the disclosed exemplary embodiments and other exemplary embodiments may be made based on the disclosure of this patent document.

What is claimed is:

1. An electrode lead structure for a secondary battery, the electrode lead structure comprising:
an electrode lead having a hole; and
a lead film formed on the electrode lead,
wherein the hole is provided to be spaced apart from an end of the electrode lead, and the lead film fills the hole.

2. The electrode lead structure of claim 1, wherein the hole is spaced at least 2.5 mm apart from the end of the electrode lead.

3. The electrode lead structure of claim 1, wherein the hole is provided in plural in the electrode lead.

4. The electrode lead structure of claim 1, wherein the holes are spaced apart from each other by 5 mm or less.

5. The electrode lead structure of claim 1, wherein the lead film includes polypropylene, polyethylene, and naphthalate.

6. A secondary battery comprising:
an electrode assembly including a negative electrode plate, a positive electrode plate, and a separator;
an electrode tab formed at one end of the electrode assembly;
the electrode lead structure for a secondary battery according to claim 1, one end of which is coupled to the electrode tab; and
a battery case wrapping the electrode assembly and the electrode tab and adhered to the lead film of the electrode lead structure.

7. The secondary battery of claim 6, wherein the lead film has adhesion of 4 to 5 N/mm with the battery case.

8. The secondary battery of claim 6, wherein
the battery case includes an upper case and a lower case adhered by the lead film, and
the upper case and the lower case have adhesion of 8 to 10 N/mm due to the lead film.
